(19) United States
(12) Patent Application Publication
(10) Pub. No.: US 2025/0218279 A1
(43) Pub. Date: Jul. 3, 2025

(54) AUTOMATICALLY STAGED HARDWARE-SWAPPING APPARATUS

(71) Applicant: Intel Corporation, Santa Clara, CA (US)

(72) Inventor: Yikui Dong, Cupertino, CA (US)

(21) Appl. No.: 18/397,793

(22) Filed: Dec. 27, 2023

(51) Int. Cl. G08C 15/00

(52) U.S. Cl. CPC G08C 15/00

(57) ABSTRACT

An apparatus is configured to generate control signals used for swapping critical hardware (e.g., a first circuit and a second circuit) in-and-out from an active communication channel for off-line calibration without disturbance to live data transmission on the communication channel. Additionally, the apparatus is configured to enable uninterrupted transmission on the communication channel without the use of a digital state-machine controller to stage the swapping. The staging function of the apparatus is accomplished organically, to secure gap-free transmission during the swapping. In operation, control signals are generated based on a single exchange signal. The control signals are used to turn ON and OFF multiple switches to enable swapping between the first circuit and the second circuit in and out of the communication channel, achieving a low BER and a continuously connected data path without a time gap and interruptions in the data transmission.

### BACKGROUND

As communication links reach higher data rates, more sophisticated methods are required to calibrate the high-precision circuits to maintain a low bit-error rate (BER). In communication devices that include such high-precision circuits, swapping critical hardware in and out from an active communication link for off-line calibration without disturbance to live data transmission can be challenging.

### BRIEF DESCRIPTION OF THE DRAWINGS

In the drawings, like numerals may describe the same or similar components or features in different views. Like numerals having different letter suffixes may represent different instances of similar components. Some embodiments are illustrated by way of example, and not limitation, in the figures of the accompanying drawings in which:

FIG. 1 is a block diagram of a generalized system with hardware-swapping background calibration, in accordance with some embodiments;

FIG. 2 is a block diagram of operating modes of the generalized system with hardware-swapping of FIG. 1, in accordance with some embodiments;

FIG. 3 is a block diagram of a prior art hardware swapping controller;

FIG. 4 is a block diagram of a prior art digital state-machine-based hardware swapping controller;

FIG. 5 is a block diagram illustrating a hardware swapping system using a dual-loop controller and a multiplexer, in accordance with some embodiments;

FIG. 6 is a block diagram illustrating a hardware swapping system using a dual-loop controller and a dynamic multiplexer (MUX), in accordance with some embodiments;

FIG. 7 is one implementation of a self-organized dual-loop controller, in accordance with some embodiments;

FIG. 8 illustrates graphical representations of output waveforms generated by the controller of FIG. 7, in accordance with some embodiments;

FIG. 9 is one implementation of the dynamic MUX of FIG. 6, in accordance with some embodiments;

FIG. 10 is one implementation of an auto-staging controller, in accordance with some embodiments;

FIG. 11 is one implementation of a dynamic MUX with positive or negative decision feedback driven by the auto-staging controller of FIG. 10, in accordance with some embodiments;

FIG. 12 is one implementation of a self-organized single-loop controller, in accordance with some embodiments;

FIG. 13 is a flow diagram of an example method for switching circuits, in accordance with some embodiments; and

FIG. 14 illustrates a block diagram of an example machine upon which any one or more of the operations/techniques (e.g., methodologies) discussed herein may perform.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

The following description and the drawings sufficiently illustrate specific embodiments to enable those skilled in the art to practice them. Other embodiments may incorporate structural, logical, electrical, process, and other changes. Portions and features of some embodiments may be included in or substituted for those of other embodiments. Embodiments outlined in the claims encompass all available equivalents of those claims.

As used herein, the term “chip” (or die) refers to a piece of a material, such as a semiconductor material, that includes a circuit, such as an integrated circuit or a part of an integrated circuit. The term “memory IP” indicates memory intellectual property. The terms “memory IP,” “memory device,” “memory chip,” and “memory” are interchangeable.

The term “a processor” configured to carry out specific operations includes both a single processor configured to carry out all of the operations (e.g., operations or methods disclosed herein) as well as multiple processors individually configured to carry out some or all of the operations (which may overlap) such that the combination of processors carry out all of the operations.

The disclosed techniques can be used to configure the swapping of hardware in and out from an active communication link for offline calibration without disturbance to live data transmission. Furthermore, with the proposed techniques, no digital state-machine controller is required to stage the swapping to guarantee an uninterrupted transmission channel. The staging function is configured using a controller to secure a gap-free transmission channel during the swapping.

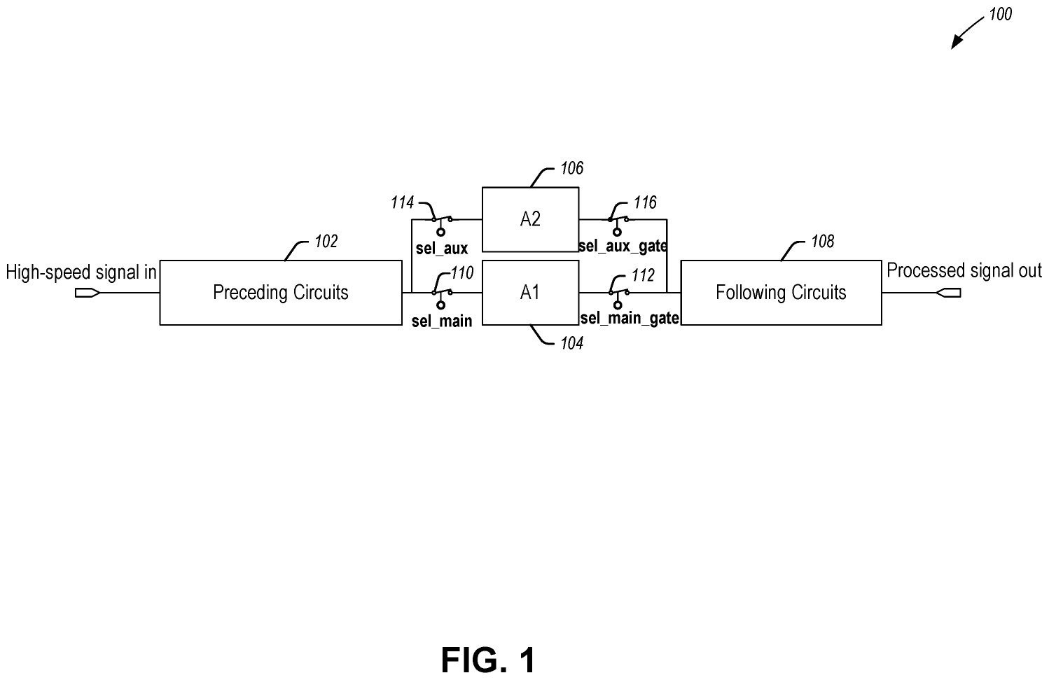

FIG. 1 is a block diagram of a generalized system 100 with hardware-swapping background calibration, in accordance with some embodiments. Referring to FIG. 1, system 100 includes circuits 104 and 106 that receive a signal from preceding circuits 102 and communicate an output signal to following circuits 108. Circuit 104 can be disconnected (e.g., for calibration) via switches 110 and 112, and circuit 106 can be disconnected (e.g., for calibration) via switches 114 and 116. Switches 110 and 112 can be controlled via corresponding control signals sel_main and sel_main_gate. Switches 114 and 116 can be controlled via corresponding control signals sel_aux and sel_aux_gate.

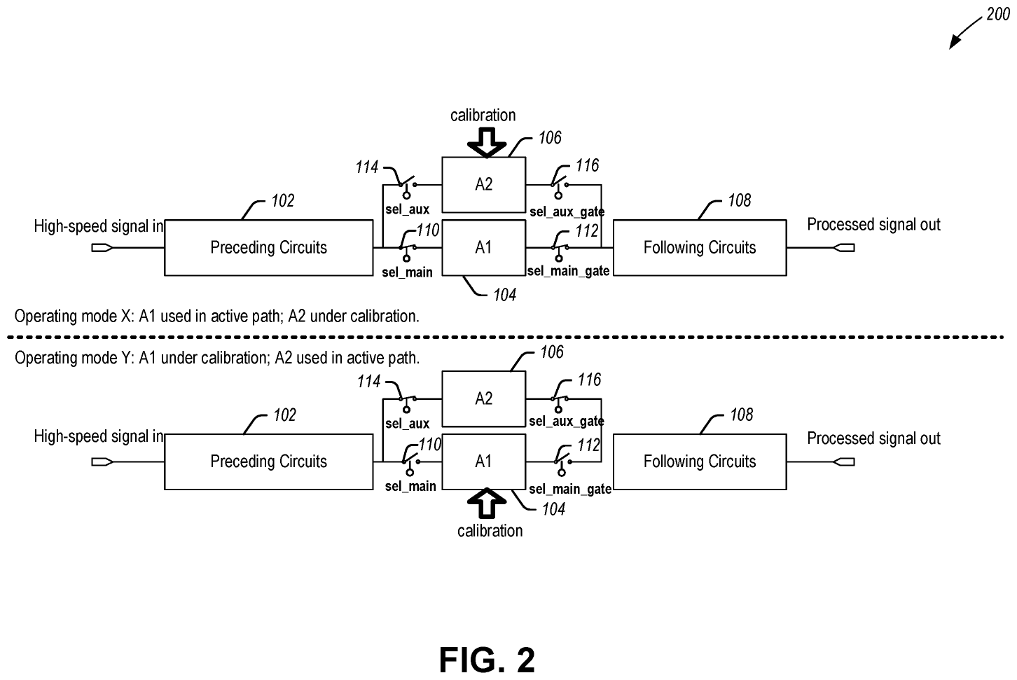

FIG. 2 is a block diagram 200 of operating modes of the generalized system with hardware-swapping of FIG. 1, in accordance with some embodiments. Referring to FIG. 2, there are illustrated two modes of operation that can rotate periodically or on-demand-mode X and mode Y, where circuits 104 and 106 (also referred to as circuit blocks A1 and A2) are swapped in and out from the data path to undergo calibration. The switching between mode X and mode Y is signified by the opening and closing of the four switches (e.g., switches 110, 112, 114, and 116) via control signals-sel_main, sel_aux, sel_main_gate, and sel_aux_gate.

In some aspects, the background calibration is operated during the transmission of live data. With the multiple switches changing between ON and OFF to swap A1 and A2 in and out to achieve low BER, it is efficient to maintain a continuously connected data path without a time gap where both circuits are inactive (or disconnected through the switches being turned OFF).

In addition, it is highly desirable to complete the hardware swapping quickly, preferably within 1 to 2 unit intervals (UI) of the incoming high-speed data, to minimize the duration of noise disturbance or coupling with other adaptation loops.

The disclosed techniques include such hardware swapping arrangements for background live calibration that feature:
(a) Gap-free data path guarantee. A continuously connected data path without a time gap is always maintained, regardless of the hardware swapping activities and the PVT variations of the underlying circuits.
(b) Minimal transition time. With the proposed techniques, the hardware swapping completes quickly, e.g., within the propagation time of a few logic gates. This guarantees fast swapping completed within 1 to 2UI of the incoming high-speed data.
(c) Automatically staged. With the proposed techniques, no digital state-machine controller is required. The multiple control phases required for gap-free hardware swapping are organized automatically. In this regard, a single “push button” hardware swapping is achieved (e.g., initiated and performed based on issuing a single trigger command, also referred to as an exchange command)

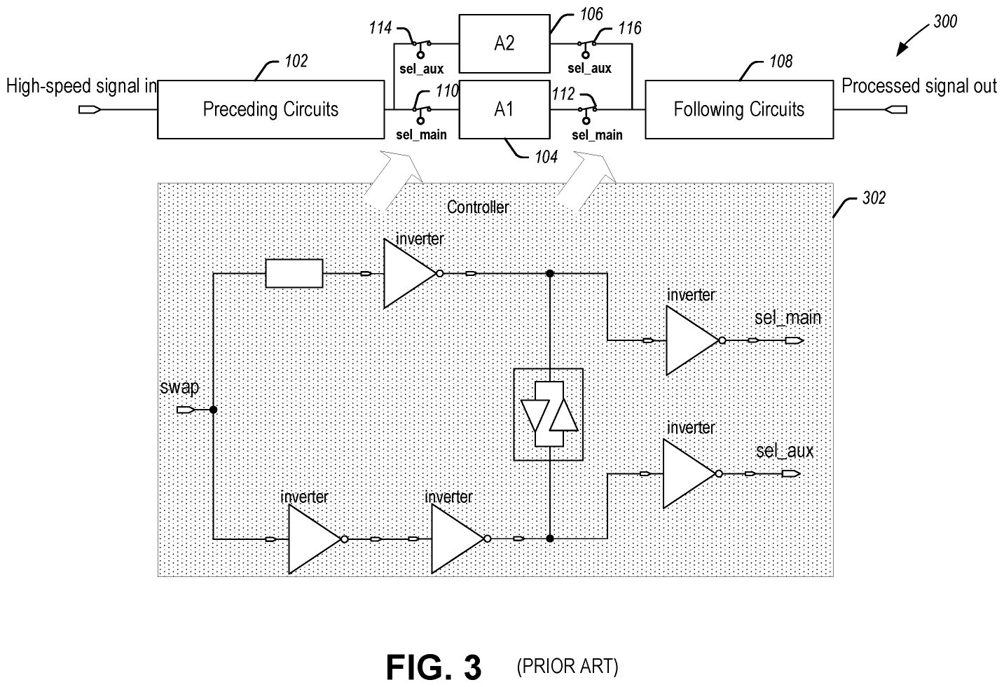

FIG. 3 is a block diagram of a prior art hardware swapping controller 302, which can be used to generate control signals to swap circuits 104 and 106. In system 300 in FIG. 3, controller 302 generates only a single control signal sel_aux for controlling the activation/deactivation of circuit 106 (sel_aux is used as a control signal for both switch 114 and switch 116) and a single control signal sel_main for controlling the activation/deactivation of circuit 104 (sel_main is used as a control signal for both switch 110 and switch 112).

However, system 300 can be associated with the following drawbacks:

The disadvantages of this solution are:
(a) Configuring sel_main and sel_aux to switch at the same time (e.g., by design and layout) as well as to match the circuit and wiring delays can be challenging.
(b) It is challenging to achieve simultaneous switching over process-voltage-temperature variations (PVT) (e.g., Slow-N/Fast-P or Fast-N/Slow-P cases).
(c) No mechanism to recover sel_main and sel_aux delay mismatch resulting from routing parasitic R and C differences among them along the communication path.
(d) Both ends of circuit 104 or circuit 106 switch at the same time, and no “setup time” is used for A1 and A2 circuits before swapping in. Additionally, no “hold-time” is allowed for the A1 and A2 circuits after the swapping. As a result, the “gap-free” operation is NOT guaranteed. With high-speed data transmissions, significant glitches or even dropping of bits could occur.

With the approach of FIG. 3, over PVT, temporary disconnection in the data path during hardware swapping can occur, and a continuously connected path is not guaranteed for live data traffic.

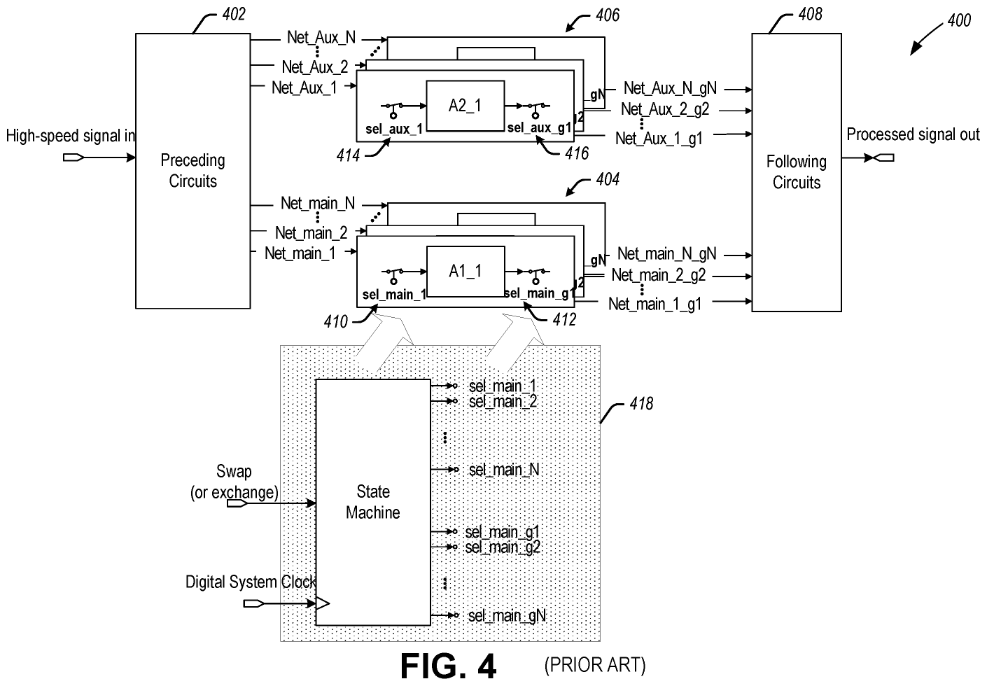

FIG. 4 is a block diagram of a prior art digital state-machine-based hardware swapping controller, in accordance with some embodiments. Referring to FIG. 4, system 400 includes circuits 404 and 406, with each circuit being subdivided into corresponding sub-circuits. For example, circuit 404 includes sub-circuits A1_1 through A1_N, and circuit 406 includes sub-circuits A2_1 through A2_N. Circuits 404 and 406 receive signals from preceding circuits 402 and output signals to following circuits 408.

Controller 418 includes a digital state machine driven by a system clock that can be used to generate multiple phases to control the switches. A state-machine-based controller 418 can be configured to generate control signals to control one or more of switches 414, 416 (for each sub-circuit of circuit 406) and switches 410, 412 (for each sub-circuit of circuit 404). However, such a system clock can be associated with a lower speed than the speed of incoming data.

With the solution illustrated in FIG. 4, the A1 and A2 circuits are partitioned into multiple slices, and a digital state machine is used to turn ON one slice of the A1 circuit and turn OFF one slice of the A2 circuit at a time, or vice versa. This way, N or N−1 slices of total A1 and A2 parts are active at any given time. The gap-free channel for live data to pass through is guaranteed. However, system 400 can be associated with the following disadvantages:
(a) System 400 is digital state machine-based. A digital system clock, which is of lower speed compared with the incoming high-speed data, drives the state machine. As a result, one hardware swapping step can take tens of thousands of UIs of incoming high-speed data. This spreads noise disturbance over large amounts of data packets and can interact with other adaptation loops.
(b) Excessive wire loading to the critical node in the high-speed data path, resulting from slicing the circuit block A1 and A2 into N parts. The extensive loading can limit the achievable bandwidth of the high-speed data path.
(c) Routing complexity and congestion from the state machine to the target circuit A1 or A2. The number of control wiring needed quickly increases with the number of slices required.

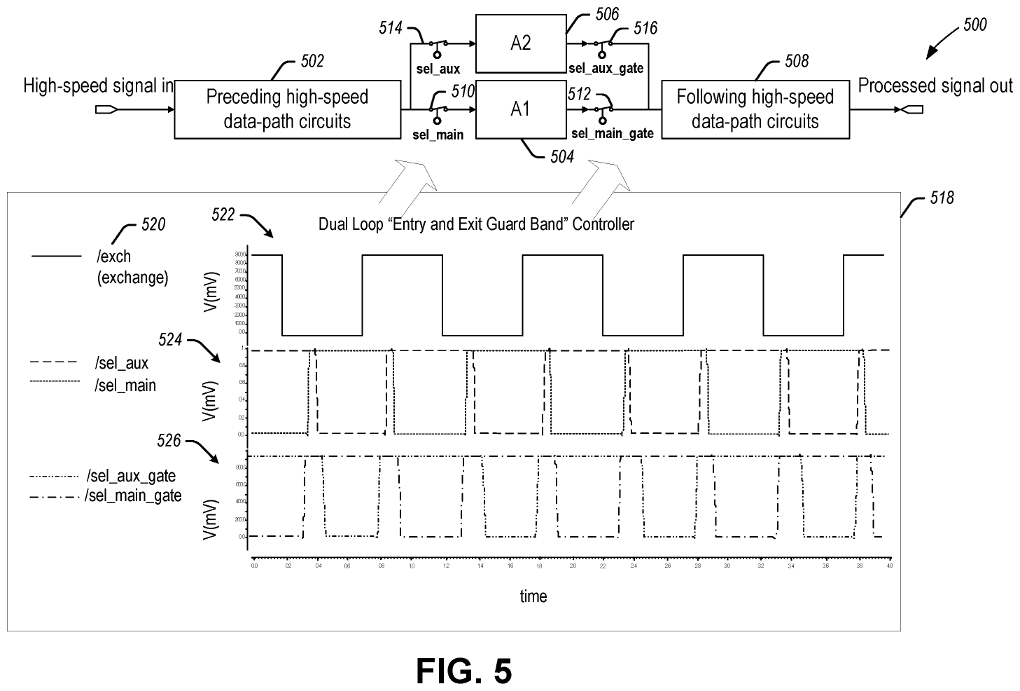

The disclosed techniques include a hardware swapping apparatus (e.g., as discussed in connection with FIGS. 5-13) for background live calibration of high-speed circuits. The disclosed apparatus is associated with the following features:
(a) Gap-free: continuous communication channel is guaranteed at any time for high-speed data transmission, regardless of whether or not hardware swapping is activated.
(b) Self-organize. The multiple control phases coordinating hardware swapping in and out functions are generated organically (e.g., no state machine-based controller is required).
(c) Instantaneous transition. The swapping action can be completed within 1 to 2UI of the high-speed data, imposing minimal impact on the overall system performance.

The proposed architecture can be used to enable background live calibration by hardware swapping with high performance and minimal overhead. Beyond high-speed transceivers, the proposed concept can be applied to general high-performance circuit systems that target various applications.

FIG. 5 is a block diagram illustrating a hardware swapping system using a dual-loop controller and a multiplexer, in accordance with some embodiments. Referring to FIG. 5, system 500 includes circuits 504 and 506 that receive a signal from preceding circuits 502 and communicate an output signal to following circuits 508. Circuit 504 (also referred to as A1 or circuit A1) can be disconnected (e.g., for calibration) via switches 510 and 512, and circuit 106 (also referred to as A2 or circuit A2) can be disconnected (e.g., for calibration) via switches 514 and 516. Switches 510 and 512 can be controlled via corresponding control signals sel_main and sel_main_gate. Switches 514 and 516 can be controlled via corresponding control signals sel_aux and sel_aux_gate.

Control signals sel_main, sel_main_gate, sel_aux, and sel_aux_gate can be generated by the dual-loop controller 518. Controller 518 is referred to as a “dual-loop” because two control signals are generated for each of the circuits A1 and A2. In some aspects, swapping between circuits A1 and A2, as well as the generation of corresponding control signals sel_main, sel_main_gate, sel_aux, and sel_aux_gate to achieve the swapping) can be initiated based on control signal 520 (also referred to as exchange signal or “exch”). FIG. 5 also illustrates signal diagrams 522 (for the exchange signal), 524 (for control signals sel_main and sel_aux), and 526 (for control signals sel_main_gate and sel_aux_gate).

The dual-loop controller 518 can be configured with an entry and exit guard band where both circuits A1 and A2 are turned ON for a pre-configured time before the swapping takes place. The ON or OFF state of switches 510, 512, 514, and 516 is controlled via control signals sel_main, sel_main_gate, sel_aux, and sel_aux_gate, respectively.

As shown in FIG. 5, the incoming control signal “exch” indicates whether the A1 path or the A2 path is intended to be active in the time to come. When “exch” turns HIGH, the A2 path (also referred to as the AUX path) is desired to turn active, while the A1 path (also referred to as the main path) is desired to turn offline for calibration, and vice versa.

As mentioned above, controller 518 guarantees no gap for live data transmission by keeping both A1 and A2 active for a short time span during switching. This is achieved by, for example, as shown in FIG. 5, after “exch” turns HIGH, sel_aux_gate turns HIGH, while sel_main_gate still keeps the previous state of HIGH; then sel_aux turns from LOW to HIGH, while sel_main still keeps the previous state of HIGH; then sel_main turns from HIGH to LOW; then sel_main_gate turns from HIGH to LOW. This controlled transition sequence ensures that no gap and no significant glitch could occur even with high-speed data transmission. Furthermore, this automatically staged sequence occurs fast and without the requirement of a digital state machine for coordination.

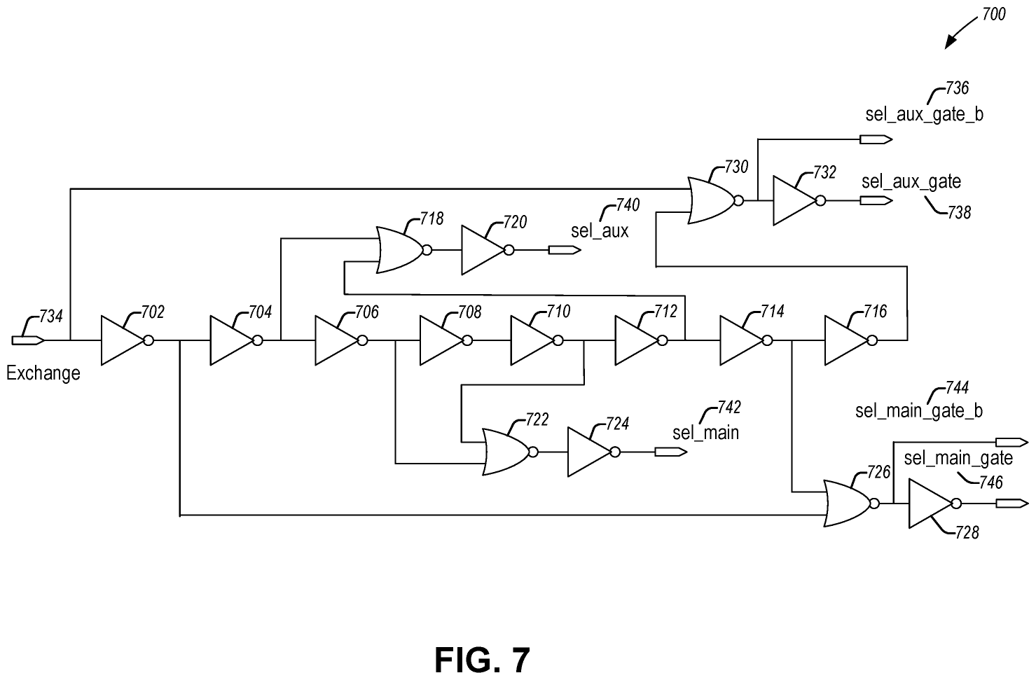

An example implementation of the dual-loop controller 518 is provided in FIG. 7.

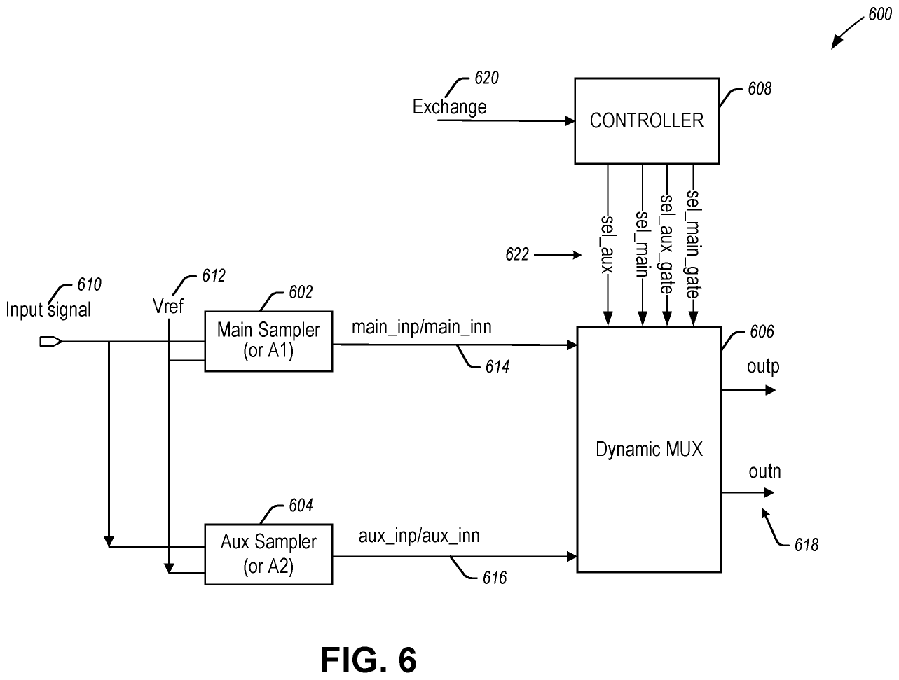

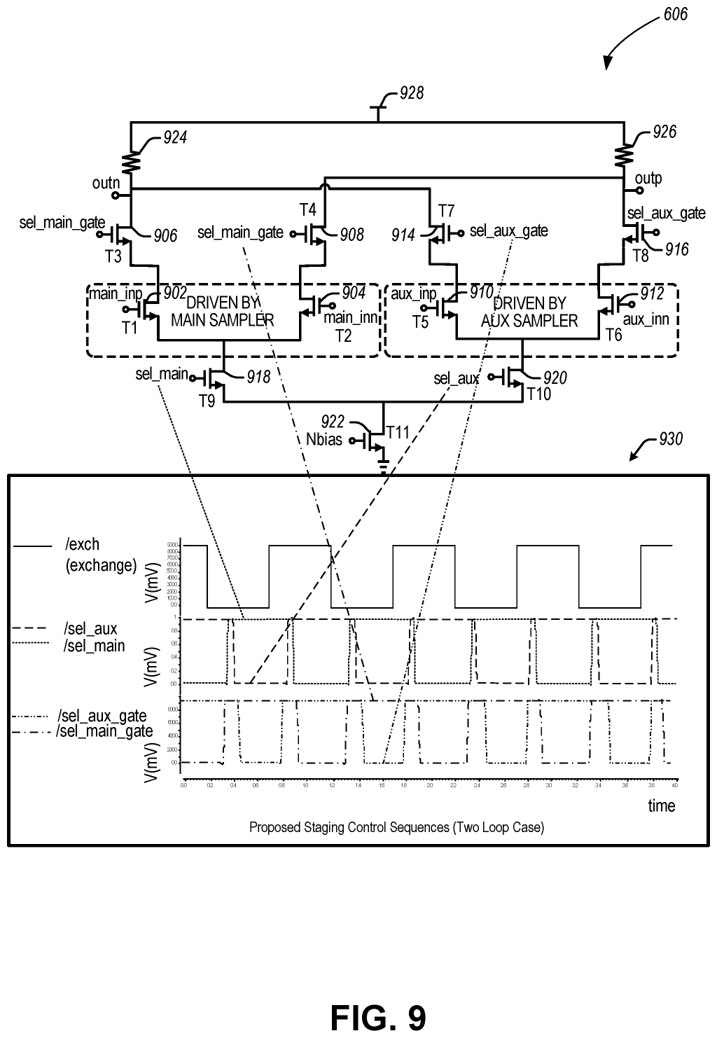

FIG. 6 is a block diagram illustrating a hardware swapping system 600 using a dual-loop controller and a dynamic multiplexer (MUX), in accordance with some embodiments. Referring to FIG. 6, hardware swapping system 600 includes a first circuit (e.g., a main sampler 602, also referred to as A1 or circuit A1) and a second circuit (e.g., an auxiliary sampler 604, also referred to as A1 or circuit A2). The hardware swapping system 600 also includes a multiplexer (MUX) 606 and controller 608. A more detailed diagram of the controller is provided in FIG. 7, and a more detailed diagram of the MUX 606 is provided in FIG. 9.

In operation, circuits A1 and A2 sample input signal 610 based on a voltage reference 612 to generate respective differential signal 614 (e.g., main_inp and main_inn) and differential signal 616 (e.g., aux_inp and aux_inn). Controller 608 is configured to generate control signals 622 (e.g., sel_main, sel_main_gate, sel_aux, and sel_aux_gate) based on an exchange signal 620. MUX 606 is configured to swap circuits A1 and A2 based on the control signals 622 and generate an output differential signal 618 (e.g., outp and outn) based on one of the differential signals 614 and 616.

FIG. 7 is one implementation of a self-organized dual-loop controller 700, in accordance with some embodiments. Referring to FIG. 7, the dual-loop controller 700 includes inverters 702, 704, 706, 708, 710, 712, 714, 716, 720, 724, 728, and 732. The dual-loop controller 700 also includes NOR gates 718, 722, 726, and 730. In operation, the dual-loop controller 700 generates the following control signals based on the exchange signal 734: sel_aux 740, sel_main 742, sel_aux_gate 738, sel_aux_gate_b 736 (e.g., a bar or an inverse signal of control signal 738), sel_main_gate 746, and sel_main_gate_b 744 (e.g., a bar or an inverse signal of control signal 746).

As shown in FIG. 7, the control signals (also referred to as control phases) sel_main, sel_aux, sel_main_gate, and sel_aux_gate are derived from one unified signal (e.g., exchange signal 734) automatically. The transition between the control phases is fast, which can be in the order of the propagation delay of several logic gates. This guarantees the swift hardware-swapping completion within 1-2UI of the high-speed data transmission.

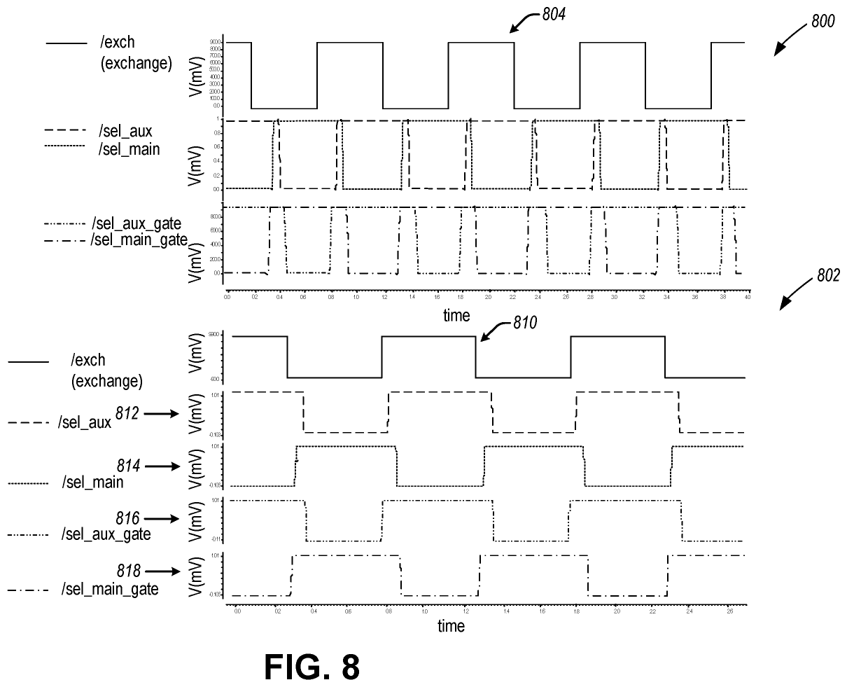

FIG. 8 illustrates graphical representations 800 and 802 of output waveforms generated by the controller of FIG. 7, in accordance with some embodiments. More specifically, graphical representations 800 and 802 include overlapping characteristics of the exchange signal and the output waves generated by the controller in FIG. 7. For example, graphical representation 800 includes graph 804 (of the exchange signal), graph 806 (of sel_aux and sel_main), and graph 808 (of sel_main_gate and sel_aux_gate). Graphical representation 802 includes non-overlapping graphs 810 (of the exchange signal), graph 812 (of sel_aux), graph 814 (of sel_main), graph 816 (of sel_aux_gate), and graph 818 (of sel_main_gate).

FIG. 9 is one implementation of the dynamic MUX 606 of FIG. 6, in accordance with some embodiments. Referring to FIG. 9, the dynamic MUX 606 includes N-channel metal-oxide semiconductor (NMOS) transistors 902, 904, 906, 908, 910, 912, 914, 916, 918, 920, and 922 (also references as corresponding T1, T2, T3, T4, T5, T6, T7, T8, T9, T10, and T11) connected as illustrated in FIG. 9. The dynamic MUX 606 also includes resistors 924 and 926 and voltage rail 928.

NMOS transistors T1 and T2 are gate-driven by differential signal 614 (main_inp and main_inn) generated by the main sampler 602. NMOS transistors T5 and T6 are gate-driven by differential signal 616 (aux_inp and aux_inn) generated by the auxiliary sampler 604. The output nodes are indicated as outp and outn in FIG. 9.

FIG. 9 also illustrates graphical representation 930 (which is the same as graphical representation 800), including a graph of the exchange signal, a graph of sel_aux and sel_main, and a graph of sel_main_gate and sel_aux_gate.

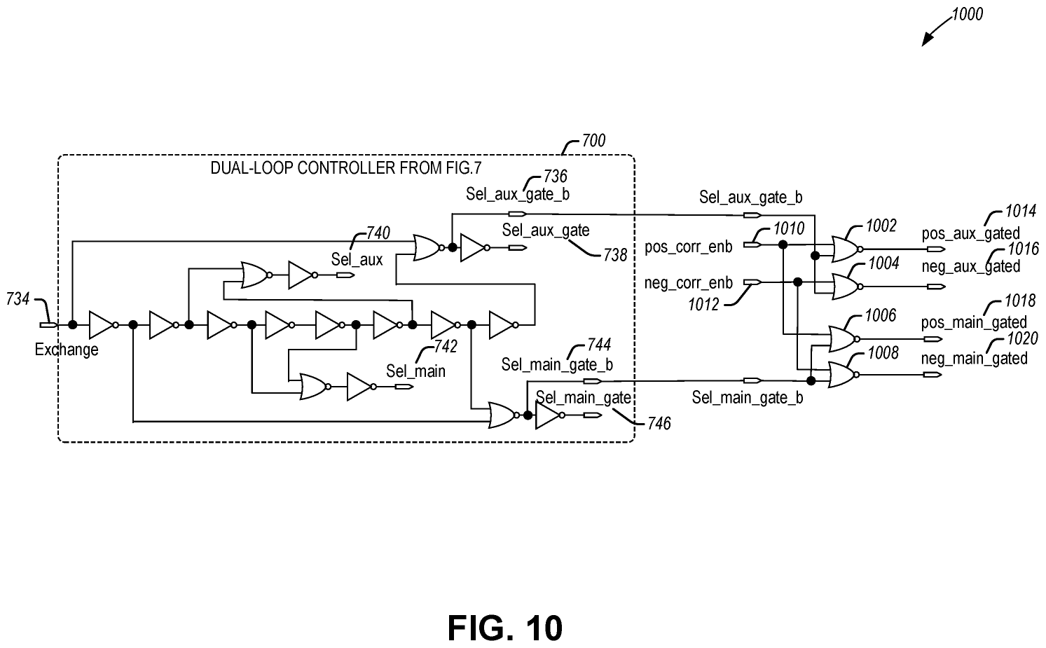

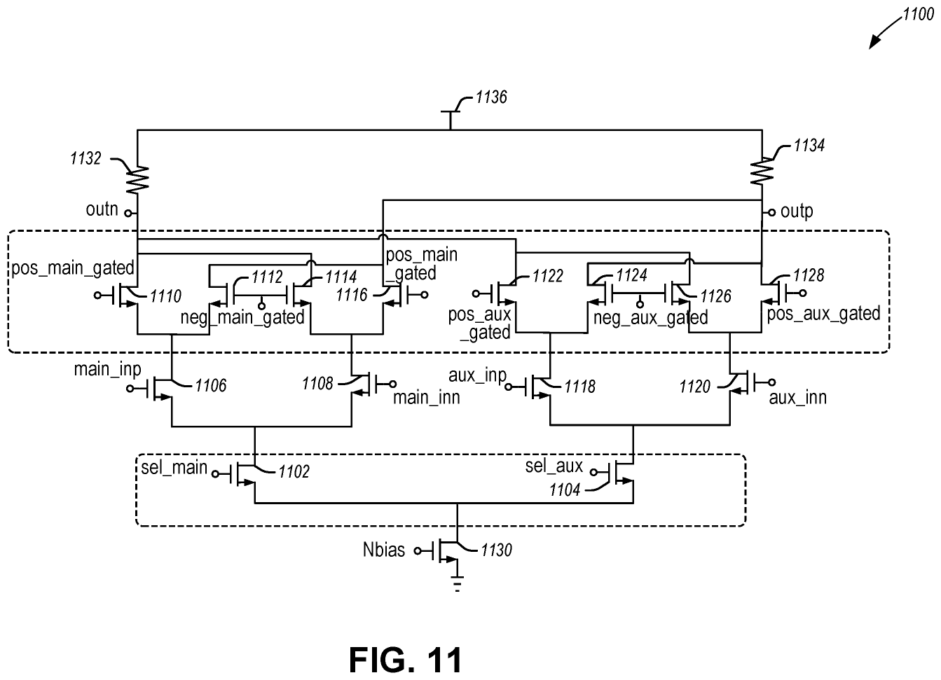

An example embodiment of an auto-staging dynamic MUX with built-in positive or negative decision feedback is shown in FIG. 11, and an example embodiment of a controller generating control signals for the dynamic MUX of FIG. 11 is shown in FIG. 10.

FIG. 10 is one implementation of an auto-staging controller 1000, in accordance with some embodiments. Referring to FIG. 10, the auto-staging controller 1000 can build upon the dual-loop controller 700 of FIG. 7 and can include additional inverters 1002, 1004, 1006, and 1008. In operation, the auto-staging controller 1000 generates control signals 736, 738, 740, 742, 744, and 746. Inverters 1002, 1004, 1006, and 1008 generate additional control signals 1014, 1016, 1018, and 1020 based on control signals 736 and 744, as well as positive correlation enable signal 1010 and negative correlation enable signal 1012. The control signals generated by the auto-staging controller 1000 are used by the dynamic MUX 1100 of FIG. 11.

FIG. 11 is one implementation of a dynamic MUX 1100 with positive or negative decision feedback driven by the auto-staging controller of FIG. 10, in accordance with some embodiments. Referring to FIG. 10, the dynamic MUX 1100 includes NMOS transistors 1102, 1104, 1106, 1108, 1110, 1112, 1114, 1116, 1118, 1120, 1122, 1124, 1126, 1128, and 1130 connected as illustrated in FIG. 11. The dynamic MUX 1100 also includes resistors 1132 and 1134 and voltage rail 1136. The output nodes are indicated as outp and outn in FIG. 11.

FIG. 11 also indicates how the input differential signals and the control signals from the auto-staging controller 1000 are used as gate voltages in the dynamic MUX 1100. More specifically, the incoming positive or negative decision feedback equalization (DFE) correction indicator (pos_corr_enb or neg_corr_enb) is masked by the sel_aux_gate_b output of the auto-staging controller 1000 to generate pos_aux_gated and neg_aux_gated to control the upper portion of the dynamic MUX 1100. When sel_aux_gate_b is logic1 (i.e., sel_aux_gate is logic0), the pos_aux_gated and neg_aux_gated are forced to be logic0. This turns OFF the upper portion of the dynamic MUX for the auxiliary path. On the other hand, when sel_aux_gate is logic1, sel_aux_gate_b is logic0, the pos_aux_gated and neg_aux_gated would reflect the inverse of the pos_corr_enb and neg_corr_enb values. Similarly, the main path side of the dynamic MUX is controlled by the sel_main_gate_b.

In some aspects, the dynamic MUX 1100 can auto-stage the hardware swapping between the MAIN and the AUX path for background offset calibration of the MAIN or the AUX samplers. It combines the negative-or-positive DFE feedback with a portion of the MUX function without adding extra loading to the high-speed path. The other side of the MUX function is implemented by pseudo complementary sel_main and sel_aux bias switches, while there exists a brief overlapping timespan during which both switches are ON. This eliminates possible high-Z state seen by the Nbias current source during hardware swapping time. It ensures smooth swapping without glitches.

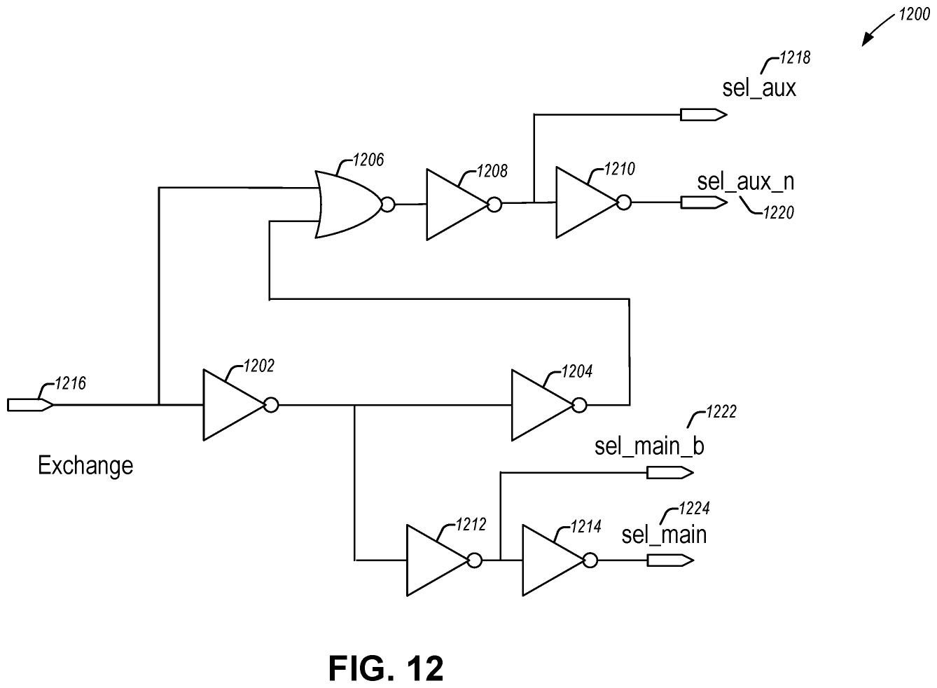

An example embodiment of a single-loop controller is shown in FIG. 12. It can be used in applications where only one set of switches is needed for swapping. FIG. 12 is one implementation of a self-organized single-loop controller 1200, in accordance with some embodiments. Referring to FIG. 12, single-loop controller 1200 includes inverters 1202, 1204, 1208, 1210, 1212, and 1214, and NOR gate 1206.

In operation, single-loop controller 1200 generates control signals 1218, 1220, 1222, and 1224 based on an input signal 1216 (e.g., an exchange signal) which can be an indication of a requested circuit swap between A1 and A2.

In some embodiments, the disclosed techniques associated with self-organized instantaneous and gap-free hardware-swapping apparatus can be extended to an N-loop (where N is an integer greater than 2) beyond the single-loop or dual-loop implementations detailed in reference to FIGS. 5-12.

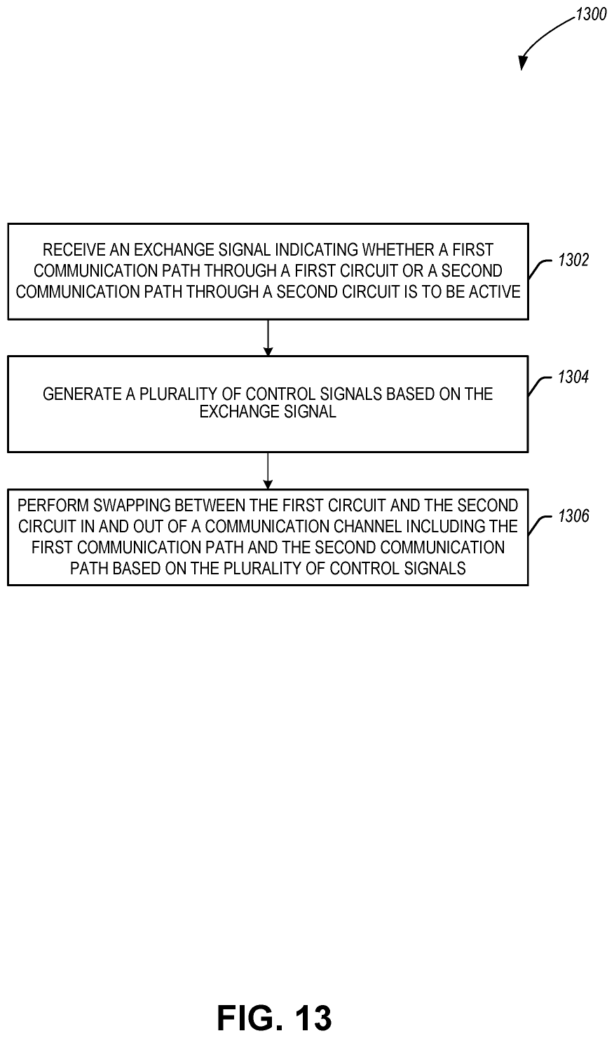

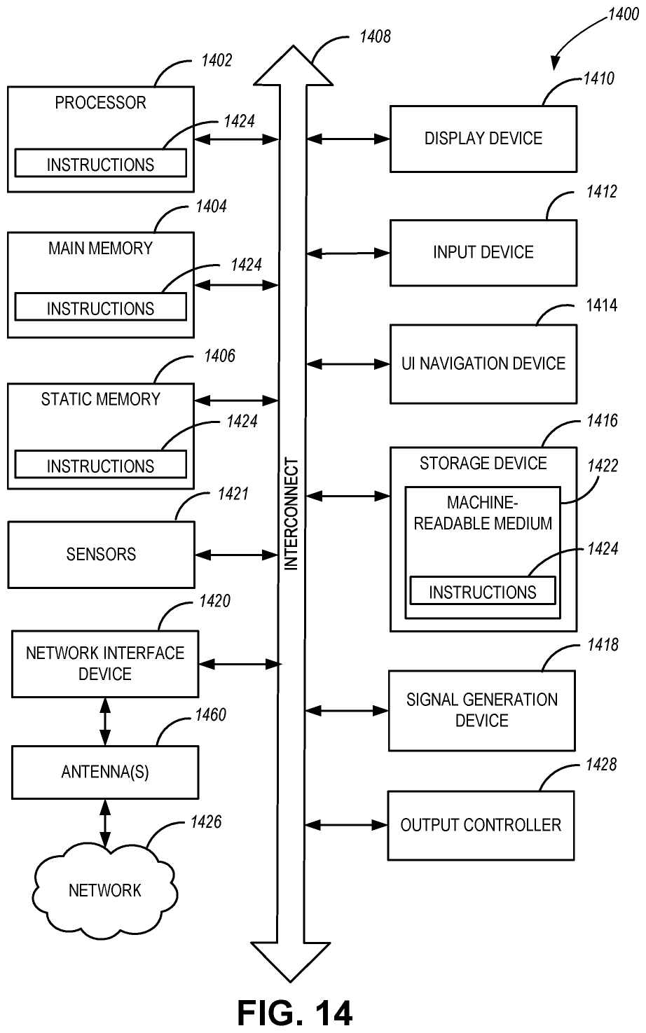

FIG. 13 is a flow diagram of an example method 1300 for switching circuits, in accordance with some embodiments. Referring to FIG. 13, method 1300 includes operations 1302, 1304, and 1306, which may be executed by an embedded controller or another processor of a computing device (e.g., hardware processor 1402 of machine 1400 illustrated in FIG. 14, which can include one or more of the circuits discussed in connection with FIGS. 1-12). In some embodiments, one or more of the circuits discussed in connection with FIGS. 1-12 can perform the functionalities listed in FIG. 13, as well as in the examples listed below.

At operation 1302, an exchange signal is received (e.g., exchange signal 734). The exchange signal indicates whether a first communication path through a first circuit (e.g., A1) or a second communication path through a second circuit (e.g., A2) is to be active. The first communication path and the second communication path can be part of a communication channel between a third circuit (e.g., preceding circuits 502) and a fourth circuit (e.g., following circuits 508).

At operation 1304, a plurality of control signals is generated based on the exchange signal (e.g., control signals 736-746).

At operation 1306, swapping between the first circuit and the second circuit in and out of a communication channel is performed based on the plurality of control signals. The communication channel includes the first communication path and the second communication path. The swapping can take place without interrupting a data transmission between the third circuit and the fourth circuit using the communication channel.

FIG. 14 illustrates a block diagram of an example machine 1400 upon which any one or more of the techniques (e.g., methodologies) discussed herein may perform. In alternative embodiments, the machine 1400 may operate as a standalone device or may be connected (e.g., networked) to other machines. In a networked deployment, machine 1400 may operate in the capacity of a server machine, a client machine, or both in server-client network environments. In an example, machine 1400 may function as a peer machine in a peer-to-peer (P2P) (or other distributed) network environment. The machine 1400 may be a personal computer (PC), a tablet PC, a set-top box (STB), a personal digital assistant (PDA), a portable communications device, a mobile telephone, a smartphone, a web appliance, a network router, switch or bridge, or any other computing device capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. The terms “machine,” “computing device,” and “computer system” are used interchangeably.

Machine (e.g., computer system) 1400 may include a hardware processor 1402 (e.g., a central processing unit (CPU), a graphics processing unit (GPU), a hardware processor core, or any combination thereof), a main memory 1404, and a static memory 1406, some or all of which may communicate with each other via an interlink (e.g., bus) 1408. In some aspects, the main memory 1404, the static memory 1406, or any other type of memory (including cache memory) used by machine 1400 can be configured based on the disclosed techniques or can implement the disclosed memory devices.

Specific examples of main memory 1404 include Random Access Memory (RAM) and semiconductor memory devices, which may include, in some embodiments, storage locations in semiconductors such as registers. Specific examples of static memory 1406 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

Machine 1400 may further include a display device 1410, an input device 1412 (e.g., a keyboard), and a user interface (UI) navigation device 1414 (e.g., a mouse). In an example, the display device 1410, the input device 1412, and the UI navigation device 1414 may be a touchscreen display. The machine 1400 may additionally include a storage device (e.g., drive unit or another mass storage device) 1416, a signal generation device 1418 (e.g., a speaker), a network interface device 1420, and one or more sensors 1421, such as a global positioning system (GPS) sensor, compass, accelerometer, or other sensors. The machine 1400 may include an output controller 1428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments, the hardware processor 1402 and/or instructions 1424 may comprise processing circuitry and/or transceiver circuitry.

The storage device 1416 may include a machine-readable medium 1422 on which one or more sets of data structures or instructions 1424 (e.g., software) embodying or utilized by any one or more of the techniques or functions described herein can be stored. Instructions 1424 may also reside, completely or at least partially, within the main memory 1404, within static memory 1406, or the hardware processor 1402 during execution thereof by the machine 1400. In an example, one or any combination of the hardware processor 1402, the main memory 1404, the static memory 1406, or the storage device 1416 may constitute machine-readable media.

Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine-readable medium 1422 is illustrated as a single medium, the term “machine-readable medium” may include a single medium or multiple media (e.g., a centralized or distributed database and/or associated caches and servers) configured to store instructions 1424.

An apparatus of the machine 1400 may be one or more of a hardware processor 1402 (e.g., a central processing unit (CPU), a graphics processing unit (GPU), a hardware processor core, or any combination thereof), a main memory 1404 and a static memory 1406, one or more sensors 1421, a network interface device 1420, one or more antennas 1460, a display device 1410, an input device 1412, a UI navigation device 1414, a storage device 1416, instructions 1424, a signal generation device 1418, and an output controller 1428. The apparatus may be configured to perform one or more of the methods and/or operations disclosed herein. The apparatus may be intended as a component of machine 1400 to perform one or more of the methods and/or operations disclosed herein and/or to perform a portion of one or more of the methods and/or operations disclosed herein. In some embodiments, the apparatus may include a pin or other means to receive power. In some embodiments, the apparatus may include power conditioning hardware.

The term “machine-readable medium” may include any medium that is capable of storing, encoding, or carrying instructions for execution by machine 1400 and that causes machine 1400 to perform any one or more of the techniques of the present disclosure or that is capable of storing, encoding, or carrying data structures used by or associated with such instructions. Non-limiting machine-readable medium examples may include solid-state memories and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine-readable media may include non-transitory machine-readable media. In some examples, machine-readable media may include machine-readable media that is not a transitory propagating signal.

The instructions 1424 may further be transmitted or received over a communications network 1426 using a transmission medium via the network interface device 1420 utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 1420 may include one or more physical jacks (e.g., Ethernet, coaxial, or phone jacks) or one or more antennas to connect to the communications network 1426. In an example, the network interface device 1420 may include one or more antennas 1460 to wirelessly communicate using at least one single-input multiple-output (SIMO), multiple-input multiple-output (MIMO), or multiple-input single-output (MISO) techniques. In some examples, the network interface device 1420 may wirelessly communicate using multiple-user MIMO techniques. The term “transmission medium” shall be taken to include any intangible medium that can store, encode, or carry instructions for execution by the machine 1400 and includes digital or analog communications signals or other intangible media to facilitate communication of such software.

Examples, as described herein, may include, or may operate on, logic or several components, modules, or mechanisms. Modules are tangible entities (e.g., hardware) capable of performing specified operations and may be configured or arranged in a particular manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part, all, or any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at separate times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM), random access memory (RAM), magnetic disk storage media, optical storage media, flash memory, etc.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof) or with respect to other examples (or one or more aspects thereof) shown or described herein.

Publications, patents, and patent documents referred to in this document are incorporated by reference herein in their entirety, as though individually incorporated by reference. In the event of inconsistent usage between this document and those documents so incorporated by reference, the usage in the incorporated reference(s) is supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc., are used merely as labels and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in several environments, such as part of a system on chip, a set of intercommunicating functional blocks, or similar, although the scope of the disclosure is not limited in this respect.

Described implementations of the subject matter can include one or more features, alone or in combination, as illustrated below by way of examples.

Example 1 is an apparatus comprising a first N-channel metal-oxide semiconductor (NMOS) transistor including a gate to receive a positive signal component of a main differential signal; a second NMOS transistor including a source coupled to a source of the first NMOS transistor, and a gate to receive a negative signal component of the main differential signal; a third NMOS transistor including a source coupled to a drain of the first NMOS transistor and a gate to receive a first switching signal; and a fourth NMOS transistor including a source coupled to a drain of the second NMOS transistor and a gate to receive the first switching signal.

In Example 2, the subject matter of Example 1 includes a fifth NMOS transistor including a gate to receive a positive signal component of an auxiliary differential signal.

In Example 3, the subject matter of Example 2 includes a sixth NMOS transistor including a source coupled to a source of the fifth NMOS transistor, and a gate to receive a negative signal component of the auxiliary differential signal.

In Example 4, the subject matter of Example 3 includes a seventh NMOS transistor including a source coupled to a drain of the fifth NMOS transistor and a gate to receive a second switching signal.

In Example 5, the subject matter of Example 4 includes an eighth NMOS transistor, a source of the eighth NMOS transistor being coupled to a drain of the sixth NMOS transistor, and a gate of the eighth NMOS transistor receiving the second switching signal.

In Example 6, the subject matter of Example 5 includes a ninth NMOS transistor including a drain coupled to the source of the first NMOS transistor and the source of the second NMOS transistor, and a gate to receive a third switching signal.

In Example 7, the subject matter of Example 6 includes a tenth NMOS transistor including a drain coupled to the source of the fifth NMOS transistor and the source of the sixth NMOS transistor, and a gate to receive a fourth switching signal.

In Example 8, the subject matter of Example 7 includes an eleventh NMOS transistor including a gate to receive a bias voltage signal, a source coupled to a ground potential, and a drain coupled to a source of the ninth NMOS transistor and a source of the tenth NMOS transistor.

In Example 9, the subject matter of Example 8 includes a first resistor coupled to a voltage rail and a drain of the third NMOS transistor.

In Example 10, the subject matter of Example 9 includes a second resistor coupled to the voltage rail and a drain of the eighth NMOS transistor.

In Example 11, the subject matter of Examples 1-10 includes one or more interconnects coupled to the gate of the first NMOS transistor, the gate of the second NMOS transistor, the gate of the third NMOS transistor, and the gate of the fourth NMOS transistor.

Example 12 is an apparatus comprising a multiplexer coupled to a first circuit and a second circuit and a controller coupled to the multiplexer and configured to receive an exchange signal, the exchange signal based on a first communication path through the first circuit or a second communication path through the second circuit is to be active; generate a plurality of control signals based on the exchange signal; perform activation or deactivation of the first circuit based on a first set of signals of the plurality of control signals; and perform activation or deactivation of the second circuit based on a second set of signals of the plurality of control signals.

In Example 13, the subject matter of Example 12 includes subject matter where to generate the plurality of control signals, the controller is configured to generate a first control signal based on the exchange signal and a first delayed version of the exchange signal; generate a second control signal based on the exchange signal and a second delayed version of the exchange signal; generate a third control signal based on a first inverted version of the exchange signal and a second inverted version of the exchange signal; and generate a fourth control signal based on the first inverted version of the exchange signal and a third inverted version of the exchange signal.

In Example 14, the subject matter of Example 13 includes subject matter where the multiplexer comprises a first switching transistor and a second switching transistor, a gate of the first switching transistor receiving the first control signal, and a gate of the second switching transistor receiving the second control signal.

In Example 15, the subject matter of Example 14 includes subject matter where the controller is configured to control switching between activation or deactivation of the first circuit based on activation or deactivation of the first switching transistor and the second switching transistor via the first control signal and the second control signal respectively.

In Example 16, the subject matter of Example 15 includes subject matter where the multiplexer comprises a third switching transistor and a fourth switching transistor, a gate of the third switching transistor receiving the third control signal, and a gate of the fourth switching transistor receiving the fourth control signal.

In Example 17, the subject matter of Example 16 includes subject matter where the controller is configured to control switching between activation or deactivation of the second circuit based on activation or deactivation of the third switching transistor and the fourth switching transistor via the third control signal and the fourth control signal respectively.

In Example 18, the subject matter of Examples 12-17 includes subject matter where the apparatus comprises a processor and wherein the processor includes one or both of the multiplexer and the controller.

In Example 19, the subject matter of Examples 12-18 includes one or more interconnects coupling the multiplexer and the controller.

Example 20 is a method comprising: receiving an exchange signal, the exchange signal based on a first communication path through a first circuit or a second communication path through a second circuit is to be active; generating a plurality of control signals based on the exchange signal; performing activation or deactivation of the first circuit based on a first set of signals of the plurality of control signals; and performing activation or deactivation of the second circuit based on a second set of signals of the plurality of control signals.

In Example 21, the subject matter of Example 20 includes maintaining the first circuit and the second circuit active for a pre-configured duration during the activation or deactivation of the first circuit and the activation or deactivation of the second circuit.

In Example 22, the subject matter of Example 21 includes subject matter where the generating of the plurality of control signals comprises generating a first control signal based on the exchange signal and a first delayed version of the exchange signal; generating a second control signal based on the exchange signal and a second delayed version of the exchange signal; generating a third control signal based on a first inverted version of the exchange signal and a second inverted version of the exchange signal; and generating a fourth control signal based on the first inverted version of the exchange signal and a third inverted version of the exchange signal.

In Example 23, the subject matter of Example 22 includes controlling switching between activation or deactivation of the first circuit based on activation or deactivation of a first switching transistor and a second switching transistor, wherein a gate of the first switching transistor receives the first control signal, and wherein a gate of the second switching transistor receives the second control signal.

In Example 24, the subject matter of Example 23 includes controlling switching between activation or deactivation of the second circuit based on activation or deactivation of a third switching transistor and a fourth switching transistor, wherein a gate of the third switching transistor receives the third control signal, and wherein a gate of the fourth switching transistor receives the fourth control signal.

Example 25 is an apparatus comprising a multiplexer coupled to a first circuit and a second circuit and a controller coupled to the multiplexer and configured to receive an exchange signal, the exchange signal based on a first communication path through the first circuit or a second communication path through the second circuit is to be active, the first communication path and the second communication path being part of a communication channel between a third circuit and a fourth circuit; generate a plurality of control signals based on the exchange signal; and communicate the control signals to the multiplexer, the control signals causing the multiplexer to perform swapping between the first circuit and the second circuit in and out of a communication channel including the first communication path and the second communication path.

In Example 26, the subject matter of Example 25 includes subject matter where the swapping takes place without interrupting a data transmission between the third circuit and the fourth circuit using the communication channel, and where to perform the swapping, the multiplexer is to perform without a state machine: activation or deactivation of the first circuit based on a first set of signals of the plurality of control signals; and perform activation or deactivation of the second circuit based on a second set of signals of the plurality of control signals.

In Example 27, the subject matter of Example 26 includes subject matter where to perform the swapping, the multiplexer is to maintain the first circuit and the second circuit active for a pre-configured duration during the activation or deactivation of the first circuit and the activation or deactivation of the second circuit.

In Example 28, the subject matter of Examples 25-27 includes subject matter where to generate the plurality of control signals, the controller is to generate a first control signal based on the exchange signal and a first delayed version of the exchange signal; generate a second control signal based on the exchange signal and a second delayed version of the exchange signal; generate a third control signal based on a first inverted version of the exchange signal and a second inverted version of the exchange signal; and generate a fourth control signal based on the first inverted version of the exchange signal and a third inverted version of the exchange signal.

In Example 29, the subject matter of Example 28 includes subject matter where the multiplexer comprises a first switching element and a second switching element, a gate of the first switching element receiving the first control signal, and a gate of the second switching element receiving the second control signal.

In Example 30, the subject matter of Example 29 includes subject matter where the controller is configured to control switching between activation or deactivation of the first circuit based on activation or deactivation of the first switching element and the second switching element via the first control signal and the second control signal respectively.

In Example 31, the subject matter of Example 30 includes subject matter where the multiplexer comprises a third switching element and a fourth switching element, a gate of the third switching element receiving the third control signal, and a gate of the fourth switching element receiving the fourth control signal.

In Example 32, the subject matter of Example 31 includes subject matter where the multiplexer is to control switching between activation or deactivation of the second circuit based on activation or deactivation of the third switching element and the fourth switching element via the third control signal and the fourth control signal respectively.

In Example 33, the subject matter of Examples 25-32 includes subject matter where the apparatus comprises a processor, and wherein the processor includes one or both of the multiplexer and the controller.

In Example 34, the subject matter of Examples 25-33 includes one or more interconnects coupling the multiplexer and the controller.

Example 35 is a method comprising receiving an exchange signal, the exchange signal based on a first communication path through a first circuit or a second communication path through a second circuit is to be active, the first communication path and the second communication path being part of a communication channel between a third circuit and a fourth circuit; and generating a plurality of control signals based on the exchange signal; and performing swapping between the first circuit and the second circuit in and out of a communication channel including the first communication path and the second communication path based on the plurality of control signals.

In Example 36, the subject matter of Example 35 includes subject matter where the swapping takes place without interrupting a data transmission between the third circuit and the fourth circuit using the communication channel, and the swapping further comprises: performing without a state machine: activation or deactivation of the first circuit based on a first set of signals of the plurality of control signals; and activation or deactivation of the second circuit based on a second set of signals of the plurality of control signals.

In Example 37, the subject matter of Example 36 includes maintaining the first circuit and the second circuit active for a pre-configured duration during the activation or deactivation of the first circuit and the activation or deactivation of the second circuit.

In Example 38, the subject matter of Examples 35-37 includes subject matter where generating the plurality of control signals comprises generating a first control signal based on the exchange signal and a first delayed version of the exchange signal; generating a second control signal based on the exchange signal and a second delayed version of the exchange signal; generating a third control signal based on a first inverted version of the exchange signal and a second inverted version of the exchange signal; and generating a fourth control signal based on the first inverted version of the exchange signal and a third inverted version of the exchange signal.

Example 39 is an apparatus comprising a first switch including first, second, and third terminals, the second terminal of the first switch to receive a positive signal component of a main differential signal; a second switch including a first terminal coupled to the first terminal of the first switch, and a second terminal to receive a negative signal component of the main differential signal; a third switch including a first terminal coupled to the third terminal of the first switch and a second terminal to receive a first switching signal; and a fourth switch including a first terminal coupled to a third terminal of the second switch and a second terminal to receive the first switching signal.

In Example 40, the subject matter of Example 39 includes a fifth switch including first, second, and third terminals, the second terminal of the fifth switch to receive a positive signal component of an auxiliary differential signal.

In Example 41, the subject matter of Example 40 includes a sixth switch including a first terminal coupled to the first terminal of the fifth switch, and a second terminal to receive a negative signal component of the auxiliary differential signal.

In Example 42, the subject matter of Example 41 includes a seventh switch including a first terminal coupled to the third terminal of the fifth switch, and a second terminal to receive a second switching signal.

In Example 43, the subject matter of Example 42 includes an eighth switch, a first terminal of the eighth switch coupled to a third terminal of the sixth switch, and a second terminal receiving the second switching signal.

In Example 44, the subject matter of Example 43 includes a ninth switch including first, second, and third terminals, the third terminal of the ninth switch coupled to the first terminal of the first switch and the first terminal of the second switch, and the third terminal of the ninth switch to receive a third switching signal.

In Example 45, the subject matter of Example 44 includes a tenth switch including first, second, and third terminals, the third terminal of the tenth switch coupled to the first terminal of the fifth switch and the first terminal of the sixth switch, and the third terminal of the tenth switch to receive a fourth switching signal.

In Example 46, the subject matter of Example 45 includes an eleventh switch including a first terminal coupled to a ground potential, a second terminal to receive a bias voltage signal, and a third terminal coupled to the first terminal of the ninth switch and the first terminal of the tenth switch.

Example 47 is at least one machine-readable medium including instructions that, when executed by processing circuitry, cause the processing circuitry to perform operations to implement any of Examples 1-46.

Example 48 is an apparatus comprising means to implement any of Examples 1-46.

Example 49 is a system to implement any of Examples 1-46.

Example 50 is a method to implement any of Examples 1-46.

The above description is intended to be illustrative and not restrictive. For example, the above-described examples (or one or more aspects thereof) may be used in combination with others. Other embodiments may be used, such as by one of ordinary skill in the art upon reviewing the above description. The abstract is to allow the reader to ascertain the nature of the technical disclosure quickly. It is submitted with the understanding that it will not be used to interpret or limit the scope or meaning of the claims. Also, in the above Detailed Description, various features may be grouped to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined regarding the appended claims, along with the full scope of equivalents to which such claims are entitled.

What is claimed is:

1. An apparatus comprising:
a multiplexer coupled to a first circuit and a second circuit; and
a controller coupled to the multiplexer and configured to:
receive an exchange signal, the exchange signal based on whether a first communication path through the first circuit or a second communication path through the second circuit is to be active, the first communication path and the second communication path being part of a communication channel between a third circuit and a fourth circuit;
generate a plurality of control signals based on the exchange signal; and
communicate the control signals to the multiplexer, the control signals causing the multiplexer to perform swapping between the first circuit and the second circuit in and out of a communication channel including the first communication path and the second communication path.

2. The apparatus of claim 1, wherein the swapping takes place without interrupting a data transmission between the third circuit and the fourth circuit using the communication channel, and wherein to perform the swapping, the multiplexer is to:
perform without a state machine:
activation or deactivation of the first circuit based on a first set of signals of the plurality of control signals; and
perform activation or deactivation of the second circuit based on a second set of signals of the plurality of control signals.

3. The apparatus of claim 2, wherein to perform the swapping, the multiplexer is to:
maintain the first circuit and the second circuit active for a pre-configured duration during the activation or deactivation of the first circuit and the activation or deactivation of the second circuit.

4. The apparatus of claim 1, wherein to generate the plurality of control signals, the controller is to:
generate a first control signal based on the exchange signal and a first delayed version of the exchange signal;
generate a second control signal based on the exchange signal and a second delayed version of the exchange signal;
generate a third control signal based on a first inverted version of the exchange signal and a second inverted version of the exchange signal; and
generate a fourth control signal based on the first inverted version of the exchange signal and a third inverted version of the exchange signal.

5. The apparatus of claim 4, wherein the multiplexer comprises a first switching element and a second switching element, a gate of the first switching element receiving the first control signal, and a gate of the second switching element receiving the second control signal.

6. The apparatus of claim 5, wherein the controller is configured to:
control switching between activation or deactivation of the first circuit based on activation or deactivation of the first switching element and the second switching element via the first control signal and the second control signal respectively.

7. The apparatus of claim 6, wherein the multiplexer comprises a third switching element and a fourth switching element, a gate of the third switching element receiving the third control signal, and a gate of the fourth switching element receiving the fourth control signal.

8. The apparatus of claim 7, wherein the multiplexer is to:
control switching between activation or deactivation of the second circuit based on activation or deactivation of the third switching element and the fourth switching element via the third control signal and the fourth control signal respectively.

9. The apparatus of claim 1, wherein the apparatus comprises a processor, and wherein the processor includes one or both of the multiplexer and the controller.

10. The apparatus of claim 1, further comprising:
one or more interconnects coupling the multiplexer and the controller.

11. A method comprising:
receiving an exchange signal, the exchange signal based on a first communication path through a first circuit or a second communication path through a second circuit is to be active, the first communication path and the second communication path being part of a communication channel between a third circuit and a fourth circuit; and
generating a plurality of control signals based on the exchange signal; and
performing swapping between the first circuit and the second circuit in and out of a communication channel including the first communication path and the second communication path based on the plurality of control signals.

12. The method of claim 11, wherein the swapping takes place without interrupting a data transmission between the third circuit and the fourth circuit using the communication channel, and wherein the swapping further comprises:
performing without a state machine:
activation or deactivation of the first circuit based on a first set of signals of the plurality of control signals; and
activation or deactivation of the second circuit based on a second set of signals of the plurality of control signals.

13. The method of claim 12, further comprising:
maintaining the first circuit and the second circuit active for a pre-configured duration during the activation or deactivation of the first circuit and the activation or deactivation of the second circuit.

14. The method of claim 11, wherein generating the plurality of control signals comprises:
generating a first control signal based on the exchange signal and a first delayed version of the exchange signal;
generating a second control signal based on the exchange signal and a second delayed version of the exchange signal;
generating a third control signal based on a first inverted version of the exchange signal and a second inverted version of the exchange signal; and
generating a fourth control signal based on the first inverted version of the exchange signal and a third inverted version of the exchange signal.

15. An apparatus comprising:
a first switch including first, second, and third terminals, the second terminal of the first switch to receive a positive signal component of a main differential signal;
a second switch including a first terminal coupled to the first terminal of the first switch, and a second terminal to receive a negative signal component of the main differential signal;
a third switch including a first terminal coupled to the third terminal of the first switch and a second terminal to receive a first switching signal; and
a fourth switch including a first terminal coupled to a third terminal of the second switch and a second terminal to receive the first switching signal.

16. The apparatus of claim 15, further comprising:
a fifth switch including first, second, and third terminals, the second terminal of the fifth switch to receive a positive signal component of an auxiliary differential signal.

17. The apparatus of claim 16, further comprising:
a sixth switch including a first terminal coupled to the first terminal of the fifth switch, and a second terminal to receive a negative signal component of the auxiliary differential signal.

18. The apparatus of claim 17, further comprising:
a seventh switch including a first terminal coupled to the third terminal of the fifth switch, and a second terminal to receive a second switching signal.

19. The apparatus of claim 18, further comprising:
an eighth switch, a first terminal of the eighth switch coupled to a third terminal of the sixth switch, and a second terminal receiving the second switching signal.

20. The apparatus of claim 19, further comprising:
a ninth switch including first, second, and third terminals, the third terminal of the ninth switch coupled to the first terminal of the first switch and the first terminal of the second switch, and the third terminal of the ninth switch to receive a third switching signal.
